(19) United States
(12) Patent Application Publication
(10) Pub. No.: US 2011/0160348 A1
(43) Pub. Date: Jun. 30, 2011

(54) USE OF STRUCTURED WATER-SOLUBLE POLYMERS OBTAINED BY CONTROLLED RADICAL POLYMERIZATION AS A DISPERSANT AND AGENT FOR ASSISTING IN THE GRINDING OF MINERAL MATERIALS

(75) Inventors: Jean-Marc Suau, Lucenay (FR); Christian Jacquemet, Lyon (FR); Yves Kensicher, Theize (FR)

(73) Assignee: COATEX S.A.S., Genay (FR)

(21) Appl. No.: 12/938,682

(22) Filed: Nov. 3, 2010

Related U.S. Application Data
(63) Continuation of application No. 10/584,147, filed on Jun. 22, 2006, now abandoned.

(30) Foreign Application Priority Data
Dec. 24, 2003 (FR) 0315385

(51) Int. Cl. C08L 33/14; C08L 43/02; C08L 51/06; C08L 53/00; C08K 3/30; C08K 3/26; C08K 3/34; C04B 26/06; C08K 3/22

(52) U.S. Cl. 524/3; 524/533; 524/555; 524/558; 524/547; 524/521; 524/522; 524/523; 524/423; 524/425; 524/446; 524/5

(57) ABSTRACT

The invention relates to the use, as a dispersant and/or a grinding aid agent for pigments and/or mineral fillers in aqueous suspension, of a water soluble polymer with a controlled structure obtained by a controlled free radical polymerization process putting into practice a particular alkoxyamine as a polymerization initiator.

The present invention relates to the field of dispersants and grinding aid agents for mineral matter, suitable respectively for improving the stability of the aqueous dispersions of mineral matter, and for facilitating the grinding of said mineral matter in aqueous suspension.

The invention relates primarily to the use, as dispersant and/or grinding aid agent for pigments and/or mineral fillers in aqueous suspension, of a water soluble polymer, with a controlled structure obtained by a controlled free radical polymerization method employing, as polymerization initiator, a particular alkoxyamine with the general formula (A):

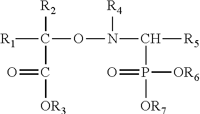

where:
R₁ and R₂ represent a linear or branched alkyl radical, with 1 to 5 carbon atoms,
R₃ is a hydrogen atom, a linear or branched alkyl radical with 1 to 8 carbon atoms, a phenyl radical, a cation such as Li⁺, Na⁺, K⁺, H₄N⁺, Bu₃HN⁺ with Bu=butyl,
R₄ is a linear or branched alkyl radical with 1 to 8 carbon atoms, and preferably a tertbutyl radical,
R₅ is a linear or branched alkyl radical with 1 to 8 carbon atoms, and preferably a tertbutyl radical,
R₆ and R₇ represent a linear or branched alkyl radical with 1 to 8 carbon atoms, and preferably an ethyl radical.

The invention further relates to methods for aqueous dispersing and for grinding of pigments and/or mineral fillers in aqueous suspensions, which put into practice this water soluble polymer.

The invention further relates to the aqueous dispersions and suspensions of pigments and/or mineral fillers thereby obtained.

The invention further relates to the use of the aqueous suspensions of pigments and/or mineral fillers thereby obtained in the paper field and in particular in the coating of the paper and the filling of the paper, or even in the fields of water based paints, plastics, cement, ceramics, detergents, cosmetics, and drilling muds.

The invention further relates to the paper formulations, water based paints, plastic compositions, cements, ceramic compositions, detergent compositions, cosmetic compositions, and the drilling muds thereby obtained.

The invention further relates to the direct use as a dispersant of said water soluble polymers in paper formulations, water based paints, cements, ceramic compositions, detergent compositions, cosmetic compositions and drilling muds.

It further relates to the paper formulations, water based paints, cements, ceramic compositions, detergent compositions, cosmetic compositions and drilling muds thereby obtained by direct use, as dispersant, of said water soluble polymers.

The manufacture, handling, transport and use of aqueous suspensions of mineral matter have always been operations in which the stability and the viscosity of these suspensions represent a crucial problem for a person skilled in the art, in order to avoid harmful mechanisms such as sedimentation, caking, pigment incompatibility or even problems of pumpability due to an excessively high viscosity.

Moreover, the person skilled in the art is also often led to perform a so-called grinding operation, which consists in reducing the size of the particles of pigments and/or mineral fillers via an input of energy, in order to adapt the particle size distribution of the particles to their intended application.

Thus, additives called “dispersants” have gradually been developed, suitable for improving the stability of said suspensions, as well as additives called “grinding aid agents” employed to facilitate the size reduction of the particles. These additives are generally based on acrylic and methacrylic polymers, as demonstrated by all the documents cited in the prior art relative to this application.

Numerous applied research projects and several patents have rapidly guided the person skilled in the art towards the choice of “controlled structure” polymers. We shall detail this concept through a number of examples and provide a precise meaning thereof, that will be used in the rest of this application.

In addition to the specific knowledge consisting of the synthesis of particular polymers, the person skilled in the art finds the following general teaching in U.S. Pat. No. 5,424,364: “controlled structure polymers” are effective dispersants for mineral fillers. Through a reading of this document, this expression must be interpreted as AB block polymers, to the detriment of polymers with a statistical architecture.

This concept is found in U.S. Pat. No. 5,231,131 which teaches the person skilled in the art that the purer these structured polymers, the more effective they are as dispersants: the privileged structure here is that of block or comb polymers, to the detriment of a random architecture.

Similarly, as regards the grinding methods, it appears in the document “Wetting and dispersing agents” (Chimia, 56, 2002, 170-176) that block copolymers can behave as very effective grinding aid agents for inorganic pigments used in paints and plastics.

In agreement with these documents, we shall therefore designate by “A method for obtaining a polymer with a controlled structure or architecture”, a method that enables the person skilled in the art to obtain a particular structure for the polymer that he wishes to prepare (such as block, comb, alternating, random, etc.).

By way of example, the person skilled in the art thus knows the documents WO 01/44388 and WO 01/44376 which describe a mineral dispersion containing water, a pigment, and a dispersant obtained by a controlled free radical polymerization method. The dispersant is a polymer having the structure of a comb with a hydrophobic skeleton and hydrophilic pendant groups. The two documents differ in the choice of the polymerization initiator: a compound containing a halide group (WO 01/44388) or a compound selected from the polyethers, polyesters, or polyurethanes (WO 01/44376).

As to the U.S. Pat. No. 4,656,226, it relates to a dispersant for pigments obtained by the GTP (Group Transfer Polymerization) technique, having a block structure of the type AB, where A is a segment consisting of polymerized methacrylic monomeric units and B is a segment consisting of polymerized methacrylic or acrylic monomeric units.

At this stage of the search, the aim of the person skilled in the art is therefore to obtain such polymers with a controlled architecture.

Pursuing his searches in this direction, the person skilled in the art then gains knowledge of the documents presenting the synthesis of controlled structure polymers, obtained by the ATRP (Atom Transfer Radical Polymerization) method. This technique has been extensively described in the document (Controlled Radical Polymerization, K. Matyjaszewski, Am. Chem. Soc., 1998, Chap16, pp 258).

Thus, the patent FR 2 797 633 describes a method for polymerizing acrylic and methacrylic monomers by ATRP. Similarly, “First example of the ATRP of an acidic monomer: direct synthesis of methacrylic acid copolymers in aqueous media” (Chem. Commun., 1999, 1285-1286) describes the use of this polymerization method applied to the synthesis of poly(ethylene oxide-sodium methacrylate) block copolymers.

Finally, document WO 00/40630 describes a composition containing an organic or inorganic pigment and a dispersant in the form of a block copolymer obtained by said technique.

However, all of these documents reveal new problems facing the person skilled in the art. On the one hand, the ATRP method employs catalysts based on copper salts which generate undesirable pollution; the copper is also found in the synthesized products, which is not necessarily the aim of the person skilled in the art. On the other hand, the ATRP method also involves amines that are often undesirable in the end product.

Faced with this serious drawback, the person skilled in the art accordingly turns to another polymerization method for obtaining controlled structures: the RAFT (Reversible Addition Fragmentation chain Transfer) technique. This technique has been extensively described in the document (Controlled/Living Radical Polymerization-Progress in ATRP, NMP, and RAFT, K. Matyjaszewski, Am. Chem. Soc., 2000, Chap20, pp 278).

In this field, the person skilled in the art knows the document WO 98/01478 which describes the synthesis of polymers of the block, graft or star type, employing a transfer agent of the R—C(═S)—S—R′ type.

At the same time, he knows the patent FR 2 821 620 which proposes a method of the RAFT type for polymerizing acrylic acid, employing a transfer agent of the R—X—C(═S)—S—R′ type. The polymer obtained can then be used as a dispersant or grinding aid agent in suspensions of mineral matter.

Yet a new problem, inherent in this polymerization technique, then appears: the use of sulfur bearing transfer agents. Apart from the drawback of being dangerous to the environment, these transfer agents impart a very unpleasant smell to the polymers obtained, and introduce not necessarily desirable organosulfur compounds into the end product.

To circumvent this new drawback, the person skilled in the art finally turns to the recent controlled free radical polymerization techniques, which employ nitroxides or alkoxyamines as polymerization initiators.

Thus the document WO 00/71501 teaches him that particular polyalkoxyaminees can be used to synthesize triblock copolymers in particular, each block being produced from monomers as different as alkyl acrylates and styrene derivatives, with excellent control of the polymerization and of the polydispersity index. However, this document does not reveal any particular use of said polymers.

Finally, the document WO 01/02345 teaches the person skilled in the art that polyalkoxyamines are suitable for obtaining controlled structure polymers such as block, comb, graft, or indeed random. These polymers have numerous applications as rheology modifiers or dispersants of mineral fillers in aqueous phase. However, this patent application reveals a serious drawback as regards the industrial manufacture of polymers. While it states in the text that the splitting of the O—C bond of the alkoxyamine selected takes place between 50 and 160° C. (page 35), it clearly appears in the examples that the operations must be conducted at temperatures substantially above 100° C. in order to be effective.

As demonstrated by examples C1 to C9 (pages 57 to 59) on the polymerization of butyl acrylate, the reaction must be carried out at 145° C. for 3 hours. In fact, in order to work in aqueous phase, as desired by the person skilled in the art to respect the environment, such temperatures make the polymerization method at atmospheric pressure impossible. Moreover, the fact of having to work at a such high temperatures is a prohibitive drawback for the synthesis of dispersants and grinding aid agents from acrylic compounds; this is because at such temperatures, operations take place near or indeed above the boiling points of the monomers used, these boiling points being 145° C., 141° C. and 161° C. respectively for butyl acrylate, acrylic acid and methacrylic acid.

Furthermore, at such temperatures, thermal initiation mechanisms occur, generating uncontrolled chains and commensurately degrinding the controlled architecture.

Pursuing his researches, the Applicant has surprisingly found the solution to the problem of obtaining stable aqueous suspensions of mineral matter employing controlled structure polymers presenting neither the pollution problems of the polymers produced by the use of copper based compounds, nor the problems of smell of the polymers obtained by the use of sulfur based compounds, nor the problems of pollution incurred by the incorporation of organosulfur compounds.

Thus the Applicant has surprisingly found that water soluble polymers with a controlled structure obtained by a controlled free radical polymerization method, at low temperature, that is at a temperature below the boiling point of the monomers employed and of water, are suitable for obtaining polymers used very effectively as dispersants and/or grinding aid agents for pigments and/or mineral fillers in aqueous suspension.

This polymerization method employs, as a polymerization initiator, a particular alkoxyamine with the general formula (A):

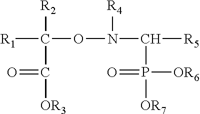

where:
R₁ and R₂ represent a linear or branched alkyl radical, with 1 to 5 carbon atoms,
R₃ is a hydrogen atom, a linear or branched alkyl radical with 1 to 8 carbon atoms, a phenyl radical, a cation such as Li⁺, Na⁺, K⁺, H₄N⁺, Bu₃HN⁺ with Bu=butyl,
R₄ is a linear or branched alkyl radical with 1 to 8 carbon atoms, and preferably a tertbutyl radical,
R₅ is a linear or branched alkyl radical with 1 to 8 carbon atoms, and preferably a tertbutyl radical,
R₆ and R₇ represent a linear or branched alkyl radical with 1 to 8 carbon atoms, and preferably an ethyl radical.

The polymers thus obtained by the method present the advantage of not containing compounds based on copper salts contrary to the polymers obtained by ATRP, and of not containing sulfur compounds as opposed to the products obtained by the RAFT technique, while having an architecture controllable via their polymerization method.

The finished products obtained are also polymers usable upon completion of the polymerization reaction directly resulting from this polymerization without any need to carry out post-treatment reactions after polymerization such as filtration, precipitation or other, reactions that change the conformation of the resulting polymer.

The object of the invention is therefore the use, as dispersant and/or grinding aid agent for pigments and/or mineral fillers in aqueous suspension, of a water soluble polymer with a controlled structure obtained by a controlled free radical polymerization method employing, as a polymerization initiator, a particular alkoxyamine with the general formula (A).

A further object of the invention resides in the aqueous dispersions and suspensions of pigments and/or mineral fillers thereby obtained.

A further object of the invention is the use of the aqueous dispersions and suspensions of pigments and/or mineral fillers thereby obtained in the paper field such as in particular the coating that employs a formulation of coating colours and the filling in the manufacture of paper sheets, water based paints, plastics, cements, ceramics, detergents, cosmetics, and drilling muds.

A further object of the invention is the paper formulations, water based paints, plastic compositions, cements, ceramic compositions, detergent compositions, cosmetic compositions, and drilling muds thereby obtained.

A further object of the invention is the direct use of said water soluble homopolymers and/or copolymers in the paper formulations, water based paints, cements, ceramic compositions, detergent compositions, cosmetic compositions, and drilling muds, as a dispersant.

A final object of the invention resides in the paper formulations, water based paints, cements, ceramic compositions, detergent compositions, cosmetic compositions, and drilling muds, obtained by the direct use of said polymers as a dispersant.

The use of said water soluble polymers according to the invention therefore makes it possible to obtain stable aqueous dispersions of pigments and/or mineral fillers and finely ground aqueous suspensions of pigments and/or mineral fillers.

These aqueous dispersions and suspensions of pigments and/or mineral fillers are suitable for obtaining paper formulations, water based paints, plastic compositions, cements, ceramic compositions, detergent compositions, cosmetic compositions and drilling muds, the viscosity of which can be controlled according to the final intended application.

Finally, the direct use of said water soluble polymers is suitable for obtaining paper formulations, water based paints, cements, ceramic compositions, detergent compositions, cosmetic compositions and drilling muds, the viscosity of which can also be regulated according to the final intended application.

These objectives are achieved thanks to the use of a water soluble polymer according to the invention, which is characterized in that said polymer has a controlled structure and is obtained by a controlled free radical polymerization method that employs, as a polymerization initiator, a particular alkoxyamine with the general formula (A).

The use of a water soluble polymer according to the invention is further characterized in that the water soluble polymer is obtained by a controlled free radical polymerization method, involving the particular alkoxyamine previously described, of monomers selected from:
a) At least one ionic monomer, which is either
   i) anionic and with a carboxylic or dicarboxylic or phosphoric or phosphonic or sulfonic function or mixture thereof, or
   ii) cationic, or
   iii) the mixture of i) and ii)
b) and possibly at least one nonionic monomer, the nonionic monomer consisting of at least one monomer with the formula (I):

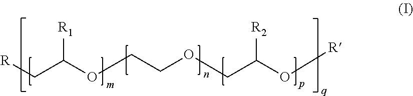

where:
   m and p represent a number of alkylene oxide motifs less than or equal to 150,
   n is a number of ethylene oxide motifs less than or equal to 150,
   q is a whole number at least equal to 1 and such that 5≦(m+n+p)q≦150, and preferably such that 15≦(m+n+p)q≦120,
   R₁ is the hydrogen or the methyl or ethyl radical,
   R₂ is the hydrogen or the methyl or ethyl radical,
   R is a radical containing a polymerizable unsaturated function, preferably belonging to the vinyl group and to the group of acrylic, methacrylic, maleic, itaconic, crotonic, vinylphthalic esters and to the group of unsaturated urethanes such as for example acrylurethane, methacrylurethane, α-α′ dimethyl-isopropenyl-benzylurethane, allylurethane, and also to the group of allyl or vinyl ethers, substituted or not, or to the group of ethylenically unsaturated amides or imides,
R′ is the hydrogen or a hydrocarbon radical with 1 to 40 carbon atoms, and is preferably a hydrocarbon radical with 1 to 12 carbon atoms and very preferably a hydrocarbon radical with 1 to 4 carbon atoms,
   or the mixture of a plurality of monomers with the formula (I),
c) and possibly at least one monomer of the acrylamide or methacrylamide type and mixtures thereof, or at least one non water soluble monomer such as the alkyl acrylates or methacrylates, the vinyl esters such as vinyl acetate, vinylpyrrolidone, styrene, alphamethylstyrene and derivatives thereof, or at least one organofluorine or organosilicon monomer or mixtures thereof,
d) and possibly at least one monomer with at least two ethylene unsaturations, referred to in the rest of the application as cross-linking monomer, or the mixture of a plurality of these monomers.

In a particular manner, the use of a water soluble polymer according to the invention is further characterized in that said water soluble polymer is obtained by the controlled free radical polymerization of monomers selected from:
a) at least one ionic monomer which is either
   i) anionic with ethylenic unsaturation and with a monocarboxylic function in the acidic or salified state selected from monomers with ethylenic unsaturation and with monocarboxylic function such as acrylic or methacrylic acid or diacid hemiesters such as the C₁ to C₄ monoesters of maleic or itaconic acids, or selected from the monomers with ethylenic unsaturation and dicarboxylic function in the acidic or salified state such as crotonic, isocrotonic, cinnamic, itaconic, maleic acid, or carboxylic acid anhydrides, such as maleic anhydride, or selected from monomers with ethylenic unsaturation and with a sulfonic function in the acidic or salified state such as acrylamido-methyl-propane-sulfonic acid, sodium methallylsulfonate, vinyl sulfonic acid and styrene sulfonic acid, or even selected from monomers with ethylenic unsaturation and with phosphoric function in the acidic or salified state such as vinyl phosphoric acid, ethylene glycol methacrylate phosphate, propylene glycol methacrylate phosphate, ethylene glycol acrylate phosphate, propylene glycol acrylate phosphate and ethoxylates thereof or even selected from monomers with ethylenic unsaturation and with phosphonic function in the acidic or salified state such as vinyl phosphonic acid or mixtures thereof, or
   ii) cationic selected from N-[3-(dimethylamino)propyl]acrylamide or N-[3-(dimethylamino)propyl]methacrylamide, unsaturated esters such as N-[2-(dimethylamino)ethyl]methacrylate, or N-[2-(dimethylamino)ethyl]acrylate, or from quaternary ammoniums such as [2-(methacryloyloxy)ethyl]trimethyl ammonium chloride or sulfate, [2-(acryloyloxy)ethyl]trimethyl ammonium chloride or sulfate, [3-(acrylamido) propyl]trimethyl ammonium chloride or sulfate, dimethyl diallyl ammonium chloride or sulfate, [3-(methacrylamido) propyl]trimethyl ammonium chloride or sulfate, or mixtures thereof, or
   iii) the mixture of the above anionic and cationic monomers
b) and possibly at least one monomer with nonionic ethylenic unsaturation with the formula (I):

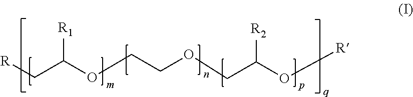

where:
   m and p represent a number of alkylene oxide motifs less than or equal to 150,
   n is a number of ethylene oxide motifs less than or equal to 150,
   q is a whole number at least equal to 1 and such that 5≦(m+n+p)q≦150, and preferably such that 15≦(m+n+p)q≦120,
   R₁ is the hydrogen or the methyl or ethyl radical,
   R₂ is the hydrogen or the methyl or ethyl radical,
   R is a radical containing a polymerizable unsaturated function, preferably belonging to the vinyl group and to the group of acrylic, methacrylic, maleic, itaconic, crotonic, vinylphthalic esters and to the group of unsaturated urethanes such as for example acrylurethane, methacrylurethane, α-α′ dimethyl-isopropenyl-benzylurethane, allylurethane, and also to the group of allyl or vinyl ethers, substituted or not, or to the group of ethylenically unsaturated amides or imides,
   R′ is the hydrogen or a hydrocarbon radical with 1 to 40 carbon atoms, and is preferably a hydrocarbon radical with 1 to 12 carbon atoms and very preferably a hydrocarbon radical with 1 to 4 carbon atoms, or the mixture of a plurality of monomers with the formula (I),
c) and possibly at least one monomer of the acrylamide or methacrylamide type and mixtures thereof, or at least one non water soluble monomer such as the alkyl acrylates or methacrylates, the vinyl esters such as vinyl acetate, vinylpyrrolidone, styrene, alphamethylstyrene and derivatives thereof, or at least one organofluorine or organosilicon monomer selected preferably from the molecules with formulas (IIa) or (IIb):

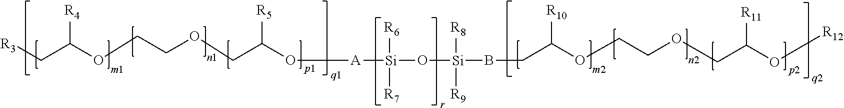

with formula (Ha)
where:
   m1, p1, m2 and p2 represent a number of alkylene oxide motifs less than or equal to 150,
   n1 and n2 represent a number of ethylene oxide motifs less than or equal to 150,
   q1 and q2 represent a whole number at least equal to 1 and such that 0≦(m1+n1+p1)q1≦150 and 0≦(m2+n2+p2)q2≦150,
   r is a number such that 1≦r≦200,
   R₃ is a radical containing a polymerizable unsaturated function, preferably belonging to the vinyl group and to the group of acrylic, methacrylic, maleic, itaconic, crotonic, vinylphthalic esters and to the group of unsaturated urethanes such as for example acrylurethane, methacrylurethane, α-α′ dimethyl-isopropenyl-benzylurethane, allylurethane, and also to the group of allyl or vinyl ethers, substituted or not, or to the group of ethylenically unsaturated amides or imides,
   R₄, R₅, R₁₀ and R₁₁, represent hydrogen or the methyl or ethyl radical,
   R₆, R₇, R₈ and R₉, represent linear or branched alkyl, or aryl, or alkylaryl, or arylalkyl groups with 1 to 20 carbon atoms, or mixtures thereof,
   R₁₂ is a hydrocarbon radical with 1 to 40 carbon atoms,
   A and B are groups that may be present, which then represent a hydrocarbon radical with 1 to 4 carbon atoms,
with the formula (IIb)

R-A-Si(OB)₃
where:
   R is a radical containing a polymerizable unsaturated function, preferably belonging to the vinyl group and to the group of acrylic, methacrylic, maleic, itaconic, crotonic, vinylphthalic esters and to the group of unsaturated urethanes such as for example acrylurethane, methacrylurethane, α-α′ dimethyl-isopropenyl-benzylurethane, allylurethane, and also to the group of allyl or vinyl ethers, substituted or not, or to the group of ethylenically unsaturated amides or imides,
   A is a group that may be present, which then represents a hydrocarbon radical with 1 to 4 carbon atoms,
   B is a hydrocarbon radical with 1 to 4 carbon atoms,
or the mixture of a plurality of these monomers,
d) and possibly at least one cross-linking monomer selected in a non-limiting way from the group consisting of ethylene glycol dimethacrylate, trimethylolpropanetriacrylate, allyl acrylate, allyl maleates, methylene-bis-acrylamide, methylene-bis-methacrylamide, tetrallyloxyethane, triallylcyanurates, allyl ethers obtained from polyols such as pentaerythritol, sorbitol, sucrose, or others or selected from molecules with the formula (III):

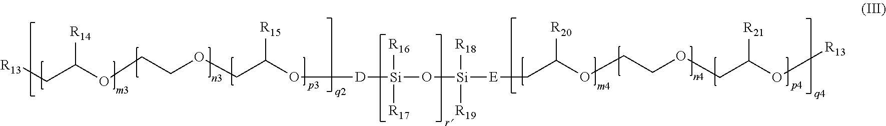

where:
   m3, p3, m4 and p4 represent a number of alkylene oxide motifs less than or equal to 150,
   n3 and n4 represent a number of ethylene oxide motifs less than or equal to 150,
   q3 and q4 represent a whole number at least equal to 1 and such that 0≦(m3+n3+p3)q3≦150 and 0≦(m4+n4+p4)q4≦150,
   r′ is a number such that 1≦r′≦200,
   R₁₃ is a radical containing a polymerizable unsaturated function, preferably belonging to the vinyl group and to the group of acrylic, methacrylic, maleic, itaconic, crotonic, vinylphthalic esters and to the group of unsaturated urethanes such as for example acrylurethane, methacrylurethane, α-α′ dimethyl-isopropenyl-benzylurethane, allylurethane, and also to the group of allyl or vinyl ethers, substituted or not, or to the group of ethylenically unsaturated amides or imides,
   R₁₄, R₁₅, R₂₀ and R₂₁, represent hydrogen or the methyl or ethyl radical,
   R₁₆, R₁₇, R₁₈ and R₁₉, represent linear or branched alkyl, or aryl, or alkylaryl, or arylalkyl groups with 1 to 20 carbon atoms, or mixtures thereof,
   D and E are groups that may be present, which then represent a hydrocarbon radical with 1 to 4 carbon atoms,
or the mixture of a plurality of these monomers.

More particularly the use of a water soluble monomer according to the invention is characterized in that said polymer consists of, expressed by weight:
a) 2% to 100% and even more particularly 5% to 100% of at least one ionic monomer, which is either
   i) anionic with ethylenic unsaturation and with a monocarboxylic function in the acidic or salified state selected from monomers with ethylenic unsaturation and with monocarboxylic function such as acrylic or methacrylic acid or diacid hemiesters such as the C₁ to C₄ monoesters of maleic or itaconic acids, or selected from the monomers with ethylenic unsaturation and dicarboxylic function in the acidic or salified state such as crotonic, isocrotonic, cinnamic, itaconic, maleic acid, or carboxylic acid anhydrides, such as maleic anhydride, or selected from monomers with ethylenic unsaturation and with a sulfonic function in the acidic or salified state such as acrylamido-methyl-propane-sulfonic acid, sodium methallylsulfonate, vinyl sulfonic acid and styrene sulfonic acid, or even selected from monomers with ethylenic unsaturation and with phosphoric function in the acidic or salified state such as vinyl phosphoric acid, ethylene glycol methacrylate phosphate, propylene glycol methacrylate phosphate, ethylene glycol acrylate phosphate, propylene glycol acrylate phosphate and ethoxylates thereof or even selected from monomers with ethylenic unsaturation and with phosphonic function in the acidic or salified state such as vinyl phosphonic acid or mixtures thereof, or
   ii) cationic selected from N-[3-(dimethylamino)propyl]acrylamide or N-[3-(dimethylamino)propyl]methacrylamide, unsaturated esters such as N-[2-(dimethylamino)ethyl]methacrylate, or N-[2-(dimethylamino)ethyl]acrylate, or from quaternary ammoniums such as [2-(methacryloyloxy)ethyl]trimethyl ammonium chloride or sulfate, [2-(acryloyloxy)ethyl]trimethyl ammonium chloride or sulfate, [3-(acrylamido)propyl]trimethyl ammonium chloride or sulfate, dimethyl diallyl ammonium chloride or sulfate, [3-(methacrylamido)propyl]trimethyl ammonium chloride or sulfate, or mixtures thereof, or
   iii) a mixture of the above anionic and cationic monomers,
b) 0 to 98% and even or particularly 0% to 96% of at least one monomer with nonionic ethylenic unsaturation with the formula (I):

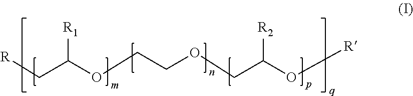

where:
   m and p represent a number of alkylene oxide motifs less than or equal to 150,
   n is a number of ethylene oxide motifs less than or equal to 150,
   q is a whole number at least equal to 1 and such that 5≦(m+n+p)q≦150, and preferably such that 15≦(m+n+p)q≦120,
   R₁ is the hydrogen or the methyl or ethyl radical,
   R₂ is the hydrogen or the methyl or ethyl radical,
   R is a radical containing a polymerizable unsaturated function, preferably belonging to the vinyl group and to the group of acrylic, methacrylic, maleic, itaconic, crotonic, vinylphthalic esters and to the group of unsaturated urethanes such as for example acrylurethane, methacrylurethane, α-α′ dimethyl-isopropenyl-benzylurethane, allylurethane, and also to the group of allyl or vinyl ethers, substituted or not, or to the group of ethylenically unsaturated amides or imides,
   R′ is the hydrogen or a hydrocarbon radical with 1 to 40 carbon atoms, and is preferably a hydrocarbon radical with 1 to 12 carbon atoms and very preferably a hydrocarbon radical with 1 to 4 carbon atoms,
or the mixture of a plurality of monomers with the formula (I),
c) 0% to 50% of at least one monomer of the acrylamide or methacrylamide type and mixtures thereof, or at least one non water soluble monomer such as the alkyl acrylates or methacrylates, the vinyl esters such as vinyl acetate, vinylpyrrolidone, styrene, alphamethylstyrene and derivatives thereof, or at least one organofluorine or organosilicon monomer selected preferably from the molecules with formulas (IIa) or (IIb):

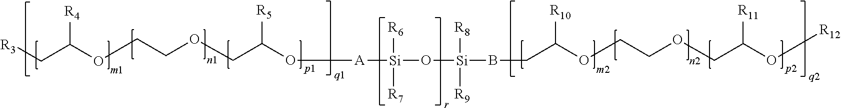

with formula (IIa)
where:
   m1, p1, m2 and p2 represent a number of alkylene oxide motifs less than or equal to 150,
   n1 and n2 represent a number of ethylene oxide motifs less than or equal to 150,
   q1 and q2 represent a whole number at least equal to 1 and such that 0≦(m1+n1+p1)q1≦150 and 0≦(m2+n2+p2)q2≦150,
   r is a number such that 1≦r≦200,
   R₃ is a radical containing a polymerizable unsaturated function, preferably belonging to the vinyl group and to the group of acrylic, methacrylic, maleic, itaconic, crotonic, vinylphthalic esters and to the group of unsaturated urethanes such as for example acrylurethane, methacrylurethane, α-α′ dimethyl-isopropenyl-benzylurethane, allylurethane, and also to the group of allyl or vinyl ethers, substituted or not, or to the group of ethylenically unsaturated amides or imides,
   R₄, R₅, R₁₀ and R₁₁, represent hydrogen or the methyl or ethyl radical,
   R₆, R₇, R₈ and R₉, represent linear or branched alkyl, or aryl, or alkylaryl, or arylalkyl groups with 1 to 20 carbon atoms, or mixtures thereof,
   R₁₂ is a hydrocarbon radical with 1 to 40 carbon atoms,
   A and B are groups that may be present, which then represent a hydrocarbon radical with 1 to 4 carbon atoms,
with the formula (IIb)

R-A-Si(OB)₃
where:
   R is a radical containing a polymerizable unsaturated function, preferably belonging to the vinyl group and to the group of acrylic, methacrylic, maleic, itaconic, crotonic, vinylphthalic esters and to the group of unsaturated urethanes such as for example acrylurethane, methacrylurethane, α-α′ dimethyl-isopropenyl-benzylurethane, allylurethane, and also to the group of allyl or vinyl ethers, substituted or not, or to the group of ethylenically unsaturated amides or imides,
   A is a group that may be present, which then represents a hydrocarbon radical with 1 to 4 carbon atoms,
   B is a hydrocarbon radical with 1 to 4 carbon atoms,
or the mixture of a plurality of these monomers,
d) 0 to 3% of at least one cross-linking monomer selected in a non-limiting way from the group consisting of ethylene glycol dimethacrylate, trimethylolpropanetriacrylate, allyl acrylate, allyl maleates, methylene-bis-acrylamide, methylene-bis-methacrylamide, tetrallyloxyethane, triallylcyanurates, allyl ethers obtained from polyols such as pentaerythritol, sorbitol, sucrose, or others, or selected from molecules with the formula (III):

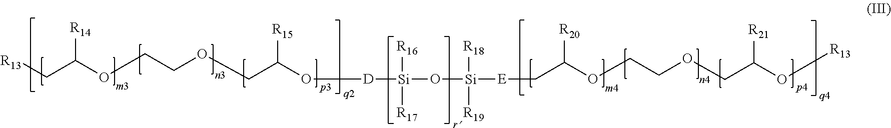

where:
   m3, p3, m4 and p4 represent a number of alkylene oxide motifs less than or equal to 150,
   n3 and n4 represent a number of ethylene oxide motifs less than or equal to 150,
   q3 and q4 represent a whole number at least equal to 1 and such that 0≦(m3+n3+p3)q3≦150 and 0≦(m4+n4+p4)q4≦150,
   r′ is a number such that 1≦r′≦200,
   R₁₃ is a radical containing a polymerizable unsaturated function, preferably belonging to the vinyl group and to the group of acrylic, methacrylic, maleic, itaconic, crotonic, vinylphthalic esters and to the group of unsaturated urethanes such as for example acrylurethane, methacrylurethane, α-α′ dimethyl-isopropenyl-benzylurethane, allylurethane, and also to the group of allyl or vinyl ethers, substituted or not, or to the group of ethylenically unsaturated amides or imides,
   R₁₄, R₁₅, R₂₀ and R₂₁, represent hydrogen or the methyl or ethyl radical,
   R₁₆, R₁₇, R₁₈ and R₁₉, represent linear or branched alkyl, or aryl, or alkylaryl, or arylalkyl groups with 1 to 20 carbon atoms, or mixtures thereof,
   D and E are groups that may be present, which then represent a hydrocarbon radical with 1 to 4 carbon atoms,
      or the mixture of a plurality of these monomers.

Finally, the use of a water soluble polymer according to the invention is characterized in that said polymer is a water soluble copolymer and has a random, block, comb, graft, or alternating type of structure.

Depending on its use, the person skilled in the art will know how to adjust the molecular weight of the polymer employed according to the invention.

This molecular weight is determined by the GPC (Gel Permeability Chromatography) method using a Waters™ liquid chromatograph equipped with two detectors of which one combines the dynamic diffusion of light with viscometry measured by a Viscotek™ viscometer and the other is a Waters™ refractometric concentration detector.

This liquid chromatograph is equipped with steric hindrance columns suitably selected by the person skilled in the art in order to separate the different molecular weights of the polymers analyzed.

The liquid elution phase is an aqueous phase.

A further object of the invention resides in the dispersants and/or grinding aid agents for mineral matter in aqueous suspension.

Thus the dispersant of mineral matter in aqueous suspension according to the invention is characterized in that the polymer is a water soluble polymer having a controlled structure and obtained by a controlled free radical polymerization method employing, as a polymerization initiator, an alkoxyamine with the general formula (A) previously defined.

It is preferably characterized in that the water soluble polymer is obtained by the controlled free radical polymerization of monomers selected from the monomers previously discussed.

Another particular manner consists in that the dispersant according to the invention is characterized in that it is a water soluble copolymer and in that it has a random, block, comb, graft or alternating structure.

Similarly, the grinding aid agent for mineral matter according to the invention is characterized in that the polymer is a water soluble polymer having a controlled structure and obtained by a controlled free radical polymerization method employing, as a polymerization initiator, an alkoxyamine with the general formula (A) previously defined.

It is preferably characterized in that the water soluble polymer is obtained by the controlled free radical polymerization of monomers selected from the monomers previously discussed.

Another particular manner consists in that the dispersant according to the invention is characterized in that it is a water soluble copolymer and in that is has a random, block, comb, graft, or alternating structure.

A further object of the invention resides in the method for dispersing and the method for grinding mineral matter in aqueous suspension.

The method for dispersing mineral matter according to the invention is characterized in that the water soluble polymer according to the invention is used and particularly in that 0.05% to 5% by dry weight of said polymer is used with respect to the dry weight of pigment and/or mineral filler, and very preferably between 0.1% and 3% of said polymer with respect to the dry weight of pigment and/or mineral filler.

The method for grinding mineral matter according to the invention is characterized in that the water soluble polymer according to the invention is used and particularly in that 0.05% to 5% by dry weight of said polymer is used with respect to the dry weight of pigment and/or mineral filler, and very preferably between 0.1% and 3% of said polymer with respect to the dry weight of pigment and/or mineral filler.

Finally, a further object of the invention resides in the aqueous dispersions and suspensions of pigments and/or mineral fillers obtained thanks to the use of the above water soluble polymer according to the invention.

These aqueous dispersions of mineral matter are characterized in that they contain a pigment and/or a mineral filler selected from natural or synthetic calcium carbonate, dolomites, kaolonite, talc, gypsum, lime, magnesia, titanium oxide, satin white, aluminum trioxide or even aluminum trihydroxide, silicas, mica and the mixture of these fillers together, such as the talc-calcium carbonate, calcium carbonate-kaolinite mixtures, or even mixtures of calcium carbonate with aluminum trihydroxide or aluminum trioxide, or even mixtures with synthetic or natural fibers or even co-structures of minerals such as the talc-calcium carbonate or talc-titanium dioxide co-structures or mixtures thereof.

These aqueous suspensions of mineral matter are characterized in that they contain a pigment and/or a mineral filler selected from natural or synthetic calcium carbonate, dolomites, kaolonite, talc, gypsum, lime, magnesia, titanium oxide, satin white, aluminum trioxide or even aluminum trihydroxide, silicas, mica and the mixture of these fillers together, such as the talc-calcium carbonate, calcium carbonate-kaolinite mixtures, or even mixtures of calcium carbonate with aluminum trihydroxide or aluminum trioxide, or even mixtures with synthetic or natural fibers or even co-structures of minerals such as the talc-calcium carbonate or talc-titanium dioxide co-structures or mixtures thereof.

The aqueous dispersions according to the invention are characterized in that they contain in a particular manner natural or synthetic calcium carbonate or cement and more particularly a natural calcium carbonate selected from marble, calcite, chalk or mixtures thereof.

The aqueous suspensions according to the invention are characterized in that they contain in a particular manner natural or synthetic calcium carbonate and more particularly a natural calcium carbonate selected from marble, calcite, chalk or mixtures thereof.

Finally, the above aqueous suspensions and dispersions are characterized in that they contain 0.05 to 5% by dry weight of the water soluble polymer used according to the invention with respect to the dry weight of the pigments and/or mineral fillers, and in that they contain more particularly 0.1 to 3% by dry weight of the water soluble polymer used according to the invention with respect to the dry weight of the pigment and/or mineral fillers.

A further object of the invention is the use of the aqueous dispersions and suspensions of pigments and/or mineral fillers thus obtained in the paper field such as in particular the coating of the paper putting into practice a formulation of coating colours and the filling of the paper in the manufacture of paper sheets, water based paints, plastics, cement, ceramics, detergents, drilling muds.

A further object of the invention is a method for dispersing mineral matter in a paper formulation, in a water based paint, in a cement, in a ceramic composition, in a detergent composition, in a drilling mud. This method is accordingly characterized in that the water soluble polymer according to the invention is used directly as dispersant.

A further object of the invention resides in the paper formulations, water based paints, plastic composition, cements, ceramic compositions, detergent compositions, cosmetic compositions and drilling muds obtained from said above aqueous dispersions and suspensions of pigments and/or mineral fillers.

A further object of the invention is the direct use of the polymer according to the invention as dispersant in the paper formulations, water based paints, cements, ceramic compositions, detergent compositions, cosmetic compositions and drilling muds.

A final object of the invention resides in the paper formulations, water based paints, cements, ceramic compositions, detergent compositions, cosmetic compositions and drilling muds thus obtained.

Regardless of the method for obtaining them (using the aqueous dispersions and/or suspensions of mineral matter made with said polymer and/or said copolymer, or by direct introduction of said polymer and/or said copolymer in the formulations concerned) the paper formulations, water based paints, plastic compositions, cements, ceramic compositions, detergent compositions, cosmetic compositions and drilling muds, are characterized in that they contain 0.01% to 5% by dry weights of said water soluble polymer.

The scope and advantages of the invention will be better understood from the following examples which are non-limiting.

### EXAMPLE 1

This example illustrates the obtaining of water soluble polymers put into practice according to the invention.

### Test No. 1

The following are introduced into a 1 liter glass reactor equipped with mechanical stirring and an oil bath type of heating system:
10.56 g of methacrylic acid
200 g of water
490 g of an aqueous solution containing 50% by weight of molecular weight 5000 polyethylene glycol methoxy methacrylate.

The medium is heated to 55° C. and a solution is introduced in one step consisting of 25 g of ethanol and 2.92 g of the following alkoxyamine:

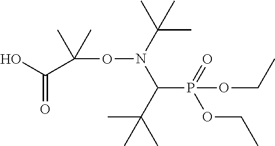

The mixture is heated for 2 hours with stirring at 60° C. and the ethanol is distilled. The medium is neutralized to pH 7 with 50% caustic soda solution.

A clear aqueous solution is obtained containing 37% of dry matter of a polymer consisting by weight of:
4.13% of methacrylic acid,
95.87% of molecular weight 5000 polyethylene glycol methoxy methacrylate of which the GPC analysis previously described indicates a weight average molecular weight of 169000.

### Test No. 2

The following are introduced into a 1 liter glass reactor equipped with mechanical stirring and an oil bath type of heating system:
10.56 g of methacrylic acid
200 g of water
490 g of an aqueous solution containing 50% by weight of molecular weight 5000 polyethylene glycol methoxy methacrylate.

The medium is heated to 65° C. and a solution is introduced in one step consisting of 25 g of ethanol and 2.92 g of the following alkoxyamine:

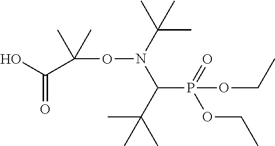

The mixture is heated for 2 hours with stirring at 70° C. and the ethanol is distilled. The medium is neutralized to pH 7 with 50% caustic soda solution.

A clear aqueous solution is obtained containing 36% of dry matter of a polymer consisting by weight of:
4.13% of methacrylic acid,
95.87% of molecular weight 5000 polyethylene glycol methoxy methacrylate of which the GPC analysis previously described indicates a weight average molecular weight of 103000.

### Test No. 3

The following are introduced into a 1 liter glass reactor equipped with mechanical stirring and an oil bath type of heating system:
16.9 g of methacrylic acid
200 g of water
490 g of an aqueous solution containing 50% by weight of molecular weight 2000 polyethylene glycol methoxy methacrylate.

The medium is heated to 65° C. and a solution is introduced in one step consisting of 25 g of ethanol and 2.92 g of the following alkoxyamine:

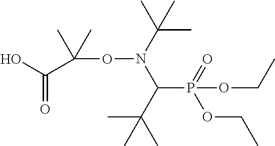

The mixture is heated for 2 hours with stirring at 70° C. and the ethanol is distilled. The medium is neutralized to pH 7 with 50% caustic soda solution.

A clear aqueous solution is obtained containing 39% of dry matter of a polymer consisting by weight of:
6.45% of methacrylic acid,
93.55% of molecular weight 2000 polyethylene glycol methoxy methacrylate of which the GPC analysis previously described indicates a weight average molecular weight of 85000.

### Test No. 4

The following are introduced into a 1 liter glass reactor equipped with mechanical stirring and an oil bath type of heating system:
10.56 g of methacrylic acid
200 g of water
490 g of an aqueous solution containing 50% by weight of molecular weight 1100 polyethylene glycol methoxy methacrylate.

The medium is heated to 65° C. and a solution is introduced in one step consisting of 25 g of ethanol and 2.92 g of the following alkoxyamine:

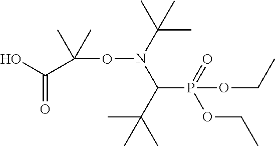

The mixture is heated for 2 hours with stirring at 70° C. and the ethanol is distilled. The medium is neutralized to pH 7 with 50% caustic soda solution.

A clear aqueous solution is obtained containing 40% of dry matter of a polymer consisting by weight of:
4.13% of methacrylic acid,
95.87% of molecular weight 1100 polyethylene glycol methoxy methacrylate of which the GPC analysis previously described indicates a weight average molecular weight of 129000.

### EXAMPLE 2

This example illustrates the putting into practice of the polymers obtained according to the invention as a grinding aid for mineral matter and more particularly for calcium carbonate. This example also illustrates the obtaining of an aqueous suspension of calcium carbonate according to the invention.

It should also be noted that these suspensions of calcium carbonate according to the invention are refined, strongly concentrated in mineral matter and easy to handle by the end user that is easily usable for paper coating and for paper filling.

### Test No. 5:

This test, which illustrates the invention, puts into practice 1.2% by dry weight of the polymer of test No. 1, with respect to the dry weight of calcium carbonate.

### Test No. 6:

This test, which illustrates the invention, puts into practice 1.2% by dry weight of the polymer of test No. 2, with respect to the dry weight of calcium carbonate.

### Test No. 7:

This test, which illustrates the invention, puts into practice 1.2% by dry weight of the polymer of test No. 3, with respect to the dry weight of calcium carbonate.

### Test No. 8:

This test, which illustrates the invention, puts into practice 1.2% by dry weight of the polymer of test No. 4, with respect to the dry weight of calcium carbonate.

For each test, an aqueous suspension was prepared using calcium carbonate from the Orgon deposit (France), with an average particle diameter of about 50 microns.

The aqueous suspension has a dry matter concentration of 78% by weight with respect to the total weight.

The grinding aid agent is introduced into this suspension according to the indicated quantities, expressed as percent by dry weight with respect to the weight of dry calcium carbonate to be ground.

The suspension circulates in a Dyno-Mill™ type of grinder with a fixed cylinder and a rotating impeller, of which the grinding material consists of corundum beads between 0.6 millimeter and 1.0 millimeter in diameter.

The total occupied by the grinding material is 1150 cubic centimeters whereas its weight is 2900 g.

The grinding chamber has a volume of 1400 cubic centimeters. The circumferential speed of the grinder is 10 meters per second.

The calcium carbonate suspension is recycled at the rate of 18 liters per hour.

The outlet of the Dyno-Mill™ grinder is equipped with a 200 micron mesh separator to separate the suspension produced by the grinding from the grinding material.

The temperature during each grinding test is kept at about 60° C.

At the end of grinding (Tₒ), a sample of the pigment suspension is recovered in a bottle. The particle size distribution of this suspension (% of particles under one micron) is measured using a Sedigraph™ 5100 granulometer manufactured by Micromeritics.

The Brookfield™ viscosity of the suspensions is measured using an RVT type Brookfield™ viscometer, at a temperature of 20° C. and speeds of rotation of 10 rpm and 100 rpm with the appropriate mobile element. The results represent the viscosity values at t=0.

After being left to rest for 8 days in the bottle, the bottle is shaken and the viscosity of the suspension is measured by introducing the appropriate spindle of the RVT type Brookfield™ viscometer into the bottle, at a temperature of 20° C. and speeds of rotation of 10 rpm and 100 rpm.

These viscosity measurements represents the APAG viscosity results at t=8 days after stirring.

All this experimental results are given in Table 1 below, which also indicates the consumption in percentage by weight of grinding aid agent used to obtain the indicated particle size distribution

TABLE 1

| | | | | Brookfield ™ Viscosities | |
|---|---|---|---|---|---|
| | Particle Size | Brookfield ™ Viscosities | | (mPa · s) at t = 8 d after | |
| Test | Distribution | (mPa · s) at t = 0 | | stirring | |
| No. | % < 1 μm | μ₁₀ | μ₁₀₀ | μ₁₀ | μ₁₀₀ |
| 5 | 58.8 | 3160 | 1220 | 5440 | 2180 |
| 6 | 57.2 | 2680 | 1025 | 4060 | 1000 |
| 7 | 56.8 | 3080 | 1020 | 2600 | 970 |
| 8 | 57.0 | 4480 | 1380 | 2940 | 1000 |

A reading of the results of Table 1 shows that the polymers according to the invention can be used as grinding aids for mineral matter in aqueous suspension, and in particular natural calcium carbonate, and that it is also possible to obtain aqueous suspensions of natural calcium carbonate containing the polymer according to the invention.

### EXAMPLE 3

This example concerns the demonstration of the use of the polymers according to the invention as cement dispersants. This example also illustrates the obtaining of the aqueous suspension of cement according to the invention.

For this purpose, for each of the tests of the example, the various components of the standard grout are poured into a grout mixer (EN 196-1) in the On position, with a real constant volume of 1 m³ per 450 kg of cement and of constant workability equal to 2 seconds measured on the Perrier worksite grout workability meter defined by standard NFP 18452.

For this purpose, the following are weighed in the bowl of the mixer:
450 g of CCB 42.5R HES Gaurain cement according to standard NF P 15-301;
the necessary quantity of water;
0.5% by dry weight of the dispersant to be tested, with respect to the weight of cement;
a variable quantity in grams of Leucate standard sand (EN 196-1). This quantity of sand being added according to standard EN 196-1 during 30 seconds and after 30 seconds of slow stirring of the mixture of components previously added.

After the end of the addition of these various components, the mixer is maintained at high speed for 30 seconds and then stopped for 90 seconds to scrape the walls of the mixer.

Once the grout adhering to the walls has been completely scraped off, the mixing is resumed for one minute at high speed.

Compliance with these time intervals enables us to obtain a mixing cycle that lasts 4 minutes and conforms to standard EN 196-1.

### Test No. 9:

This test illustrates the control and puts into practice a cement formulation without additive.

### Test No. 10:

This test illustrates the prior art and puts into practice a naphthalene sulfonate sold by Scheppens.

### Test No. 11:

This test, which illustrates the invention, puts into practice the polymer of test No. 1.

### Test No. 12:

This test, which illustrates the invention, puts into practice the polymer of test No. 3.

### Test No. 13:

This test, which illustrates the invention, puts into practice the polymer of test No. 4.

### Test No. 14:

This test, which illustrates the invention, puts into practice the polymer of test No. 2.

The quantities of components being adjusted for each of the grouts of the various tests in order to operate at a constant real volume (1 m³ per 450 kg of cement) and constant workability (2 seconds), the polymer put into practice is even more effective with less water and more sand.

The results obtained for the different tests are given in Table 2 below.

TABLE 2

| | | Prior | | | | |
|---|---|---|---|---|---|---|
| | Control | Art | Invention | Invention | Invention | Invention |
| Test | 9 | 10 | 11 | 12 | 13 | 14 |
| No. | | | | | | |
| Cement | 450 | 450 | 450 | 450 | 450 | 450 |
| (g) | | | | | | |
| Sand | 1596 | 1610 | 1635 | 1620 | 1625 | 1620 |
| (g) | | | | | | |
| Water | 248 | 225 | 210 | 200 | 200 | 200 |
| (g) | | | | | | |

A reading of the table reveals the improvement provided by the use of the copolymers according to the invention as cement dispersants.

### EXAMPLE 4

This example concerns the use of the polymers according to the invention in the field of ceramics.

For this purpose, the dispersant efficiency is evaluated of the polymers according to the invention contained in the aqueous suspensions of clay according to the invention put into practice in the field of ceramics.

For this purpose, and for each of the tests Nos. 16 to 19, 250 grams of raw water and 0.65 grams of dispersant to be tested are weighed in a 500 milliliter plastic beaker fitted with a stirring rod 60 mm in diameter.

After stirring the mixture contained in the beaker, 217.3 g of Fuchs-Ton clay for slurry, is poured in, in order to obtain a dry matter concentration of 46.5% and a test dispersant content of 0.3% by dry weight with respect to the dry weight of clay.

After 20 minutes of stirring at a speed of 750 rpm, the viscosity of the slurry is measured by measuring the RVT type Brookfield™ viscosity at 10 rpm and 100 rpm.

The various tests are as follows:

### Test No. 15:

This test is a control and uses no dispersant.

The Brookfield™ viscosities obtained are 6400 mPa·s at 10 rpm and 870 mPa·s at 100 rpm.

### Test No. 16

This test illustrates the invention and puts into practice the polymer according to the invention of test No. 1.

The Brookfield™ viscosities obtained are 6000 mPa·s at 10 rpm and 800 mPa·s at 100 rpm.

### Test No. 17:

This test illustrates the invention and puts into practice the polymer according to the invention of test No. 4.

The Brookfield™ viscosities obtained are 6000 mPa·s at 10 rpm and 800 mPa·s at 100 rpm.

### Test No. 18:

This test illustrates the invention and puts into practice the polymer according to the invention of test No. 2.

The Brookfield™ viscosities obtained are 6000 mPa·s at 10 rpm and 800 mPa·s at 100 rpm.

### Test No. 19:

This test illustrates the invention and puts into practice the polymer according to the invention of test No. 3.

The Brookfield™ viscosities obtained are 6000 mPa·s at 10 rpm and 800 mPa·s at 100 rpm.

A reading of the results of the various tests shows that the use of the polymers in the field of ceramics is feasible.

1-40. (canceled)

41. A process comprising adding at least one water soluble polymer 1) to a pigment in an aqueous suspension, 2) to a mineral filler in an aqueous suspension, or 3) to a combination thereof, wherein said at least one water soluble polymer has a controlled structure and is obtained by a controlled free radical polymerization of monomers in the presence of an alkoxyamine polymerization initiator represented by general formula (A): 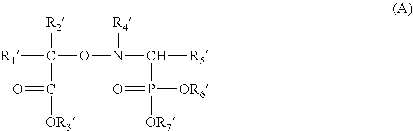
where:
R₁′ and R₂′ each independently represent a linear or branched alkyl radical with 1 to 5 carbon atoms,
R₃′ is a hydrogen atom, a linear or branched alkyl radical with 1 to 8 carbon atoms, a phenyl radical, or a cation selected from the group consisting of Li⁺, Na⁺, K⁺, H₄N⁺, and Bu₃HN⁺ where Bu is a butyl group, and
R₄′, R₅′, R₆′ and R₇′ are each independently a linear or branched alkyl radical with 1 to 8 carbon atoms,
wherein said monomers comprise:
an anionic monomer having a carboxylic functional group, a dicarboxylic functional group, a phosphoric functional group, a phosphonic functional group and a sulfonic functional group, or a combination thereof;
a cationic monomer;
a combination of said anionic monomer and said cationic monomer; and, optionally, at least one of:
a nonionic monomer represented by formula (I) 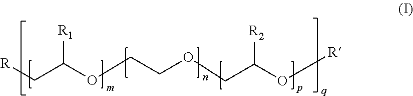
where:
m, n and p are each a number less than or equal to 150,
q is a whole number at least equal to 1 and such that 5≦(m+n+p)q≦150,
R₁ and R₂ are each independently a hydrogen, a methyl radical, or an ethyl radical,
R″ is a radical containing a polymerizable unsaturated functional group,
R′ is a hydrogen or a hydrocarbon radical with 1 to 40 carbon atoms;
a monomer selected from the group consisting of an acrylamide, a methacrylamide, a water insoluble monomer, a vinyl ester, an organofluorine compound, and an organosilicon compound; and
a cross-linking monomer.

42. The process according to claim 41, wherein R₄′ and R₅′ are each a t-butyl group and R₆′ and R₇′ are each an ethyl radical.

43. The process according to claim 41, wherein R₁′ and R₂′ each represent a methyl radical and R₃′ is a hydrogen atom.

44. The process according to claim 41, wherein said at least one water soluble polymer is a random copolymer, a block copolymer, a comb copolymer, a graft copolymer, or an alternating copolymer.

45. The process according to claim 41, wherein q is a whole number at least equal to 1 and such that 15≦(m+n+p)q≦120.

46. The process according to claim 41, wherein R″ is a radical selected from the group consisting of a vinyl radical, an acrylic radical, a methacrylic radical, a maleic radical, an itaconic radical, a crotonic radical, a vinylphthalic ester radical, an unsaturated urethane radical, a substituted or unsubstituted allyl ether radical, a substituted or unsubstituted vinyl ether radical, an ethylenically unsaturated amide radical, and an ethylenically unsaturated imide radical.

47. The process according to claim 46, wherein said unsaturated urethane radical is selected from the group consisting of acrylurethane, methacrylurethane, α-α′ dimethyl-isopropenyl-benzylurethane, and allylurethane.

48. The process according to claim 41, wherein the water insoluble monomer is selected from the group consisting of an alkyl acrylate, an alkyl methacrylate, a vinyl ester, vinylpyrrolidone, styrene, and alphamethylstyrene.

49. The process according to claim 41, wherein said anionic monomer is at least one of:
an anionic ethylenically unsaturated monomer having a monocarboxylic functional group in the acidic or salified state selected from the group consisting of acrylic acid, methacrylic acid, a C₁ to C₄ monoester of maleic acid and a C₁ to C₄ monoester of itaconic acid;
an anionic ethylenically unsaturated monomer having a dicarboxylic functional group in the acidic or salified state selected from the group consisting of crotonic acid, isocrotonic acid, cinnamic acid, itaconic acid, maleic acid, and maleic anhydride;
an anionic ethylenically unsaturated monomer having a sulfonic functional group in the acidic or salified state selected from the group consisting of acrylamido-methyl-propane-sulfonic acid, sodium methallylsulfonate, vinyl sulfonic acid and styrene sulfonic acid;
an anionic ethylenically unsaturated monomer having a phosphoric functional group in the acidic or salified state selected from the group consisting of vinyl phosphoric acid, ethylene glycol methacrylate phosphate, propylene glycol methacrylate phosphate, ethylene glycol acrylate phosphate, propylene glycol acrylate phosphate and an ethoxylate thereof; and an anionic ethylenically unsaturated monomer having a phosphonic functional group in the acidic or salified state.

50. The process according to claim 41, wherein said cationic monomer is at least one member selected from the group consisting of N-[3-(dimethylamino)propyl]acrylamide, N-[3-(dimethylamino)propyl]methacrylamide, an unsaturated ester, and a quaternary ammonium compound.

51. The process according to claim 50, wherein said unsaturated ester is selected from the group consisting of N-[2-(dimethylamino)ethyl]methacrylate and N-[2-(dimethylamino)ethyl]acrylate, and
said quaternary ammonium compound is selected from the group consisting of [2-(methacryloyloxy)ethyl]trimethyl ammonium chloride, [2-(methacryloyloxy)ethyl]trimethyl ammonium sulfate, [2-(acryloyloxy)ethyl]trimethyl ammonium chloride, [2-(acryloyloxy)ethyl]trimethyl ammonium sulfate, [3-(acrylamido) propyl]trimethyl ammonium chloride, [3-(acrylamido) propyl]trimethyl ammonium sulfate, dimethyl diallyl ammonium chloride, dimethyl diallyl ammonium sulfate, [3-(methacrylamido) propyl]trimethyl ammonium chloride, [3-(methacrylamido) propyl]trimethyl ammonium sulfate, and a combination thereof.

52. The process according to claim 41, wherein
said organofluorine compound is a compound represented by formula (IIa) 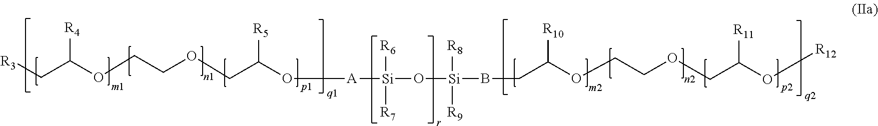
where:
each of m1, n1, p1, m2, n2, and p2 represents an integer of less than or equal to 150,
q1 and q2 represent a whole number at least equal to 1 and such that 0≦(m1+n1+p1)q1≦150 and 0≦(m2+n2+p2)q2≦150,
r is a number such that 1≦r≦200,
R₃ is a radical containing a polymerizable unsaturated functional group,
R₄, R₅, R₁₀ and R₁₁ each represent a hydrogen, a methyl radical, or an ethyl radical,
R₆, R₇, R₈ and R₉ each represent a linear or branched alkyl radical, an aryl radical, alkylaryl radical, or an arylalkyl radical with 1 to 20 carbon atoms,
R₁₂ is a hydrocarbon radical with 1 to 40 carbon atoms, and
A and B are groups that may be present, which then represent a hydrocarbon radical with 1 to 4 carbon atoms.

53. The process according to claim 51, wherein R₃ is a radical selected from the group consisting of a vinyl radical, an acrylic radical, a methacrylic radical, a maleic radical, an itaconic radical, a crotonic radical, a vinylphthalic ester radical, an unsaturated urethane radical, a substituted or unsubstituted allyl ether radical, a substituted or unsubstituted vinyl ether radical, an ethylenically unsaturated amide radical, and an ethylenically unsaturated imide radical.

54. The process according to claim 53, wherein said unsaturated urethane radical is selected from the group consisting of acrylurethane, methacrylurethane, α-α′ dimethyl-isopropenyl-benzylurethane, and allylurethane.

55. The process according to claim 41, wherein said organosilicon compound is represented by formula (IIb):
R-A′-Si(OB′)₃
where:
R is a radical containing a polymerizable unsaturated functional group,
A′ is a group that may be present, which then represents a hydrocarbon radical with 1 to 4 carbon atoms, and
B′ is a hydrocarbon radical with 1 to 4 carbon atoms.

56. The process according to claim 55, wherein each of R is selected from the group consisting of a vinyl radical, an acrylic ester radical, a methacrylic ester radical, a maleic ester radical, an itaconic ester radical, a crotonic ester radical, a vinylphthalic ester radical, an unsaturated urethane radical, a substituted or unsubstituted allyl ether radical, a substituted or unsubstituted vinyl ether radical, an ethylenically unsaturated amide radical, and an ethylenically unsaturated imide radical.

57. The process according to claim 56, wherein said unsaturated urethane radical is selected from the group consisting of acrylurethane, methacrylurethane, α-α′ dimethyl-isopropenyl-benzylurethane, and allylurethane.

58. The process according to claim 41, wherein said crosslinking monomer is a monomer selected from the group consisting of ethylene glycol dimethacrylate, trimethylolpropanetriacrylate, an allyl acrylate, an allyl maleate, methylene-bis-acrylamide, methylene-bis-methacrylamide, tetrallyloxyethane, triallylcyanurates, an allyl ether obtained from a polyol, a monomer represented by formula (III): 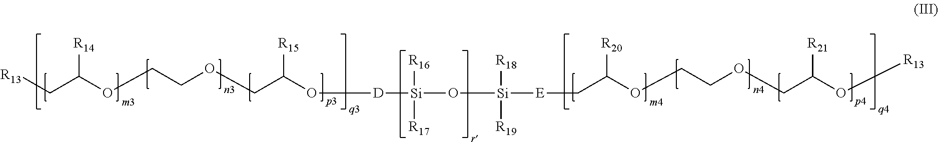
where
each of m3, n3, p3, m4, n4 and p4 represents an integer less than or equal to 150,
q3 and q4 each represent a whole number at least equal to 1 and such that 0≦(m3+n3+p3)q3≦150 and 0≦(m4+n4+p4)q4≦150,
R′ is a number such that 1≦r′≦200,
R₁₃ is a radical containing a polymerizable unsaturated functional group,
R₁₄, R₁₅, R₂₀ and R₂₁ each represent hydrogen, a methyl radical, or an ethyl radical,
R₁₆, R₁₇, R₁₈ and R₁₉ each represent a linear or branched alkyl radical, an aryl radical, an alkylaryl radical, or an arylalkyl radical with 1 to 20 carbon atoms, and
D and E are groups that may be present, which then represent a hydrocarbon radical with 1 to 4 carbon atoms;
and a combination thereof.

59. The process according to claim 58, wherein R₁₃ is a radical selected from the group consisting of a vinyl radical, an acrylic radical, a methacrylic radical, a maleic radical, an itaconic radical, a crotonic radical, a vinylphthalic ester radical, an unsaturated urethane radical, a substituted or unsubstituted allyl ether radical, a substituted or unsubstituted vinyl ether radical, an ethylenically unsaturated amide radical, and an ethylenically unsaturated imide radical.

60. The process according to claim 59, wherein said unsaturated urethane radical is selected from the group consisting of acrylurethane, methacrylurethane, α-α′ dimethyl-isopropenyl-benzylurethane, and allylurethane.

61. A process comprising adding at least one water soluble polymer 1) to a pigment in an aqueous suspension, 2) to a mineral filler in an aqueous suspension, or 3) to a combination thereof, wherein said at least one water soluble polymer has a controlled structure and is obtained by a controlled free radical polymerization of monomers in the presence of an alkoxyamine polymerization initiator represented by general formula (A): 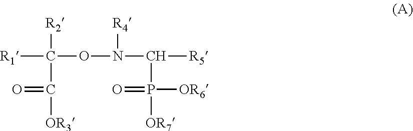
where:
R₁′ and R₂′ each independently represent a linear or branched alkyl radical with 1 to 5 carbon atoms,
R₃′ is a hydrogen atom, a linear or branched alkyl radical with 1 to 8 carbon atoms, a phenyl radical, or a cation selected from the group consisting of Li⁺,
Na⁺, K⁺, H₄N⁺, and Bu₃HN⁺ where Bu is a butyl group, and
R₄′, R₅′, R₆′ and R₇′ are each independently a linear or branched alkyl radical with 1 to 8 carbon atoms,
wherein said polymer comprises as monomer units, expressed by weight:
a) 2% to 100% of at least one ionic monomer selected from the group consisting of an ethylenically unsaturated anionic monomer having a monocarboxylic functional group in the acidic or salified state; an ethylenically unsaturated anionic monomer having a dicarboxylic functional group in the acidic or salified state; an ethylenically unsaturated anionic monomer having a sulfonic functional group in the acidic or salified state; an ethylenically unsaturated anionic monomer having a phosphoric functional group in the acidic or salified state; an ethylenically unsaturated anionic monomer having a phosphonic functional group in the acidic or salified state; N-[3-(dimethylamino)propyl]acrylamide, N-[3-(dimethylamino)propyl]methacrylamide, an unsaturated ester, and a quaternary ammonium compound,
b) 0 to 98% of at least one monomer with nonionic ethylenic unsaturation represented by formula (I): 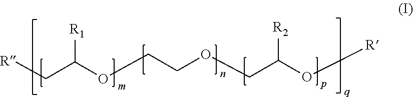
where:
m, n and p are each a number less than or equal to 150,
q is a whole number at least equal to 1 and such that 5≦(m+n+p)q≦150,
R₁ and R₂ are each independently a hydrogen, a methyl radical, or an ethyl radical,
R″ is a radical containing a polymerizable unsaturated functional group,
R′ is a hydrogen or a hydrocarbon radical with 1 to 4 carbon atoms,
c) 0% to 50% of at least one monomer selected from the group consisting of an acrylamide, a methacrylamide, a water insoluble monomer, an organofluorine compound represented by formula (IIa), and an organosilicon compound represented by formula (IIb), 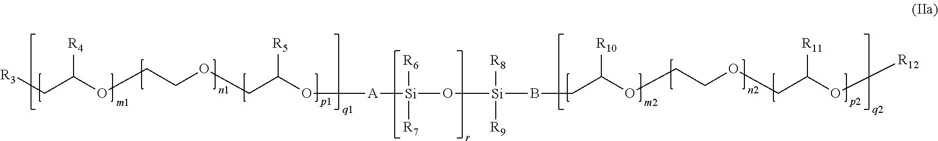
where:
each of m1, n1, p1, m2, n2, and p2 represents an integer less than or equal to 150,
q1 and q2 represent a whole number at least equal to 1 and such that 0≦(m1+n1+p1)q1≦150 and 0≦(m2+n2+p2)q2≦150,
r is a number such that 1≦r≦200,
R₃ is a radical containing a polymerizable unsaturated functional group
R₄, R₅, R₁₀ and R₁₁ each represent a hydrogen, a methyl radical, or an ethyl radical,
R₆, R₇, R₈ and R₉ each represent a linear or branched alkyl radical, an aryl radical, alkylaryl radical, or an arylalkyl radical with 1 to 20 carbon atoms,
R₁₂ is a hydrocarbon radical with 1 to 40 carbon atoms,
A and B are groups that may be present, which then represent a hydrocarbon
radical with 1 to 4 carbon atoms;
said organosilicon compound is a compound represented by formula (IIb):
R-A′-Si(OB′)₃ (IIb)
where:
R is a radical containing a polymerizable unsaturated functional group,
A′ is a group that may be present, which then represents a hydrocarbon radical with 1 to 4 carbon atoms, and
B′ is a hydrocarbon radical with 1 to 4 carbon atoms,
d) 0 to 3% of at least one cross-linking monomer selected from the group consisting of ethylene glycol dimethacrylate, trimethylolpropanetriacrylate, allyl acrylate, allyl maleates, methylene-bis-acrylamide, methylene-bis-methacrylamide, tetrallyloxyethane, triallylcyanurates, an allyl ether obtained from a polyol, and a monomer represented by formula (III): 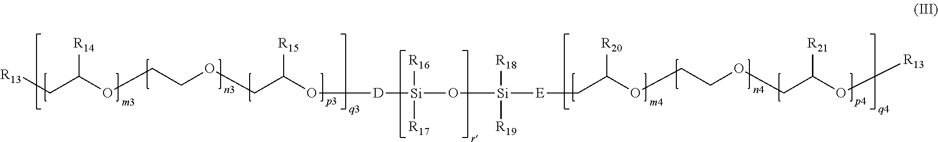
where
each of m3, n3, p3, m4, n4 and p4 represents an integer less than or equal to 150,
q3 and q4 each represent a whole number at least equal to 1 and such that 0≦(m3+n3+p3)q3≦150 and 0≦(m4+n4+p4)q4≦150,
R′ is a number such that 1≦r′≦200,
R₁₃ is a radical containing a polymerizable unsaturated functional group,
R₁₄, R₁₅, R₂₀ and R₂₁ each represent hydrogen, a methyl radical, or an ethyl radical,
R₁₆, R₁₇, R₁₈ and R₁₉ each represent a linear or branched alkyl radical, an aryl radical, an alkylaryl radical, or an arylalkyl radical with 1 to 20 carbon atoms, and
D and E are groups that may be present, which then represent a hydrocarbon radical with 1 to 4 carbon atoms.

62. The process according to claim 61, wherein each of R″, R₃ and R₁₃ are independently selected from the group consisting of a vinyl radical, an acrylic ester radical, a methacrylic ester radical, a maleic ester radical, an itaconic ester radical, a crotonic ester radical, a vinylphthalic ester radical, an unsaturated urethane radical, a substituted or unsubstituted allyl ether radical, a substituted or unsubstituted vinyl ether radical, an ethylenically unsaturated amide radical, and an ethylenically unsaturated imide radical.

63. The process according to claim 62, wherein said unsaturated urethane radical is selected from the group consisting of acrylurethane, methacrylurethane, α-α′ dimethyl-isopropenyl-benzylurethane, and allylurethane.

64. The process according to claim 61, wherein said water insoluble monomer is selected from the group consisting of an alkyl acrylate and an alkyl methacrylate.

65. The process according to claim 61, wherein the polyol of said allyl ether obtained from a polyol is selected from the group consisting of pentaerythritol, sorbitol, and sucrose.

66. The process according to claim 41, wherein said at least one water soluble polymer is present in an amount of from 0.05 to 5% by dry weight with respect to the dry weight of the pigment, the mineral filler, or a combination thereof.

67. The process according to claim 41, wherein said at least one water soluble polymer is present in an amount of from 0.1 to 3% by dry weight with respect to the dry weight of the pigment, the mineral filler, or a combination thereof.

68. The process according to claim 41, wherein the pigment and the mineral filler are each selected from the group consisting of natural calcium carbonate, synthetic calcium carbonate, dolomites, kaolonite, talc, cement, gypsum, lime, magnesia, titanium oxide, satin white, aluminum trioxide, aluminum trihydroxide, silicas, mica, talc-calcium carbonate, a calcium carbonate-kaolinite mixture, a mixture of calcium carbonate with aluminum trihydroxide, a mixture of calcium carbonate with aluminum trioxide, a mixture of synthetic fibers, natural fibers, a talc-calcium carbonate co-structure, and a talc-titanium dioxide co-structure.

69. An aqueous dispersion, comprising
water,
at least one pigment, at least one mineral filler, or a combination thereof,
and at least one water soluble polymer that has a controlled structure and is obtained by a controlled free radical polymerization of at least one monomer in the presence of, as polymerization initiator, an alkoxyamine represented by general formula (A): 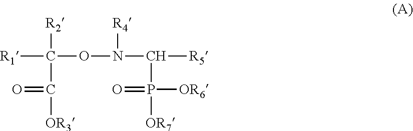
where:
R₁ and R₂ each independently represent a linear or branched alkyl radical with 1 to 5 carbon atoms,
R₃′ is a hydrogen atom, a linear or branched alkyl radical with 1 to 8 carbon atoms, a phenyl radical, or a cation selected from the group consisting of Li⁺,
Na⁺, K⁺, H₄N⁺, and Bu₃HN⁺ where Bu is a butyl group, and
R₄′, R₅′, R₆′ and R₇′ are each independently a linear or branched alkyl radical with 1 to 8 carbon atoms,
wherein said at least one monomer comprises:
an anionic monomer having a carboxylic functional group, a dicarboxylic functional group, a phosphoric functional group, a phosphonic functional group and a sulfonic functional group, or a combination thereof;
a cationic monomer; and at least one of
a combination of said anionic monomer and said cationic monomer; and, optionally, at least one of:
a nonionic monomer represented by formula (I) 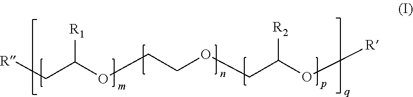
where:
m, n and p are each a number less than or equal to 150,
q is a whole number at least equal to 1 and such that 5≦(m+n+p)q≦150,
R₁ and R₂ are each independently a hydrogen, a methyl radical, or an ethyl radical,
R″ is a radical containing a polymerizable unsaturated functional group,
R′ is a hydrogen or a hydrocarbon radical with 1 to 4 carbon atoms;
a monomer selected from the group consisting of an acrylamide, a methacrylamide, a water insoluble monomer, a vinyl ester, an organofluorine compound, and an organosilicon compound; and
a cross-linking monomer,
wherein a percentage of particles of less than one micron in diameter is not greater than 58.8%,
the aqueous dispersion exhibits an initial Brookfield viscosity of at least 2680, measured at μ₁₀, and at least 1020, measured at μ₁₀₀, and
the aqueous dispersion exhibits a Brookfield viscosity, measured after resting for eight days, of at least 2600, measured at μ₁₀, and at least 970, measured at μ₁₀₀.

70. The aqueous dispersion according to claim 69, wherein R₄′ and R₅′ are each independently a t-butyl group and R₆′ and R₇′ are each independently an ethyl radical.

71. The aqueous dispersion according to claim 69, wherein R₁′ and R₂′ each represent a methyl radical and R₃′ is a hydrogen atom.

72. The aqueous dispersion according to claim 69, wherein said at least one water soluble polymer is a random copolymer, a block copolymer, a comb copolymer, a graft copolymer, or an alternating copolymer.

73. The aqueous dispersion according to claim 69, wherein said alkoxyamine represented by general formula (A) is 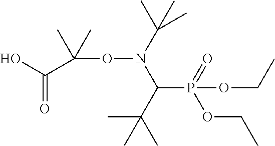
said at least one monomer is methacrylic acid, and
said at least one pigment, at least one mineral filler, or a combination thereof is calcium carbonate and said polymer is present in an amount 1.2% by weight, relative to the amount of calcium carbonate.

74. The aqueous dispersion according to claim 69, wherein q is a whole number at least equal to 1 and such that 15≦(m+n+p)q≦120.

75. The aqueous dispersion according to claim 69, wherein R″ is a radical selected from the group consisting of a vinyl radical, an acrylic radical, a methacrylic radical, a maleic radical, an itaconic radical, a crotonic radical, a vinylphthalic ester radical, an unsaturated urethane radical, a substituted or unsubstituted allyl ether radical, a substituted or unsubstituted vinyl ether radical, an ethylenically unsaturated amide radical, and an ethylenically unsaturated imide radical.

76. The aqueous dispersion according to claim 75, wherein said unsaturated urethane radical is selected from the group consisting of acrylurethane, methacrylurethane, α-α′ dimethyl-isopropenyl-benzylurethane, and allylurethane.

77. The aqueous dispersion according to claim 69, wherein said water insoluble monomer is selected from the group consisting of an alkyl acrylate, an alkyl methacrylate, a vinyl ester, vinylpyrrolidone, styrene, alphamethylstyrene, and a combination thereof.

78. The aqueous dispersion according to claim 69, wherein said at least one anionic monomer is at least one of:
an anionic ethylenically unsaturated monomer having a monocarboxylic functional group in the acidic or salified state selected from the group consisting of acrylic acid, methacrylic acid, a C₁ to C₄ monoester of maleic acid and a C₁ to C₄ monoester of itaconic acid;
an anionic ethylenically unsaturated monomer having a dicarboxylic functional group in the acidic or salified state selected from the group consisting of crotonic acid, isocrotonic acid, cinnamic acid, itaconic acid, maleic acid, and maleic anhydride;
an anionic ethylenically unsaturated monomer having a sulfonic functional group in the acidic or salified state selected from the group consisting of acrylamide-methyl-propane-sulfonic acid, sodium methallylsulfonate, vinyl sulfonic acid and styrene sulfonic acid;
an anionic ethylenically unsaturated monomer having a phosphoric functional group in the acidic or salified state selected from the group consisting of vinyl phosphoric acid, ethylene glycol methacrylate phosphate, propylene glycol methacrylate phosphate, ethylene glycol acrylate phosphate, propylene glycol acrylate phosphate and an ethoxylate thereof; and
an anionic ethylenically unsaturated monomer having a phosphonic functional group in the acidic or salified state.

79. The aqueous dispersion according to claim 69, wherein said cationic monomer is at least one member selected from the group consisting of N-[3-(dimethylamino)propyl]acrylamide, N-[3-(dimethylamino)propyl]methacrylamide, an unsaturated ester, and a quaternary ammonium compound.

80. The aqueous dispersion according to claim 79, wherein said unsaturated ester is selected from the group consisting of N-[2-(dimethylamino)ethyl]methacrylate and N-[2-(dimethylamino)ethyl]acrylate, and
said quaternary ammonium compound is selected from the group consisting of [2-(methacryloyloxy)ethyl]trimethyl ammonium chloride, [2-(methacryloyloxy)ethyl]trimethyl ammonium sulfate, [2-(acryloyloxy)ethyl]trimethyl ammonium chloride, [2-(acryloyloxy)ethyl]trimethyl ammonium sulfate, [3-(acrylamido) propyl]trimethyl ammonium chloride, [3-(acrylamido) propyl]trimethyl ammonium sulfate, dimethyl diallyl ammonium chloride, dimethyl diallyl ammonium sulfate, [3-(methacrylamido) propyl]trimethyl ammonium chloride, [3-(methacrylamido) propyl]trimethyl ammonium sulfate, and a mixture thereof.

81. The aqueous dispersion according to claim 69, wherein
said organofluorine compound is a compound represented by formula (IIa) 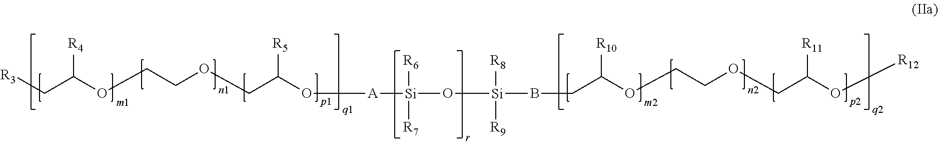
where:
each of m1, n1, p1, m2, n2, and p2 represents an integer less than or equal to 150,
q1 and q2 represent a whole number at least equal to 1 and such that 0≦(m1+n1+p1)q1≦150 and 0≦(m2+n2+p2)q2≦150,
r is a number such that 1≦r≦200,
R₃ is a radical containing a polymerizable unsaturated functional group,
R₄, R₅, R₁₀ and R₁₁ each represent a hydrogen, a methyl radical, or an ethyl radical,
R₆, R₇, R₈ and R₉ each represent a linear or branched alkyl radical, an aryl radical, alkylaryl radical, or an arylalkyl radical with 1 to 20 carbon atoms,
R₁₂ is a hydrocarbon radical with 1 to 40 carbon atoms,
A and B are groups that may be present, which then represent a hydrocarbon radical with 1 to 4 carbon atoms.

82. The process according to claim 81, wherein R₃ is a radical selected from the group consisting of a vinyl radical, an acrylic radical, a methacrylic radical, a maleic radical, an itaconic radical, a crotonic radical, a vinylphthalic ester radical, an unsaturated urethane radical, a substituted or unsubstituted allyl ether radical, a substituted or unsubstituted vinyl ether radical, an ethylenically unsaturated amide radical, and an ethylenically unsaturated imide radical.

83. The process according to claim 82, wherein said unsaturated urethane radical is selected from the group consisting of acrylurethane, methacrylurethane, α-α′ dimethyl-isopropenyl-benzylurethane, and allylurethane.

84. The process according to claim 69, wherein said organosilicon compound is a compound represented by formula (IIb):
R-A′-Si(OB′)₃
where:
R is a radical containing a polymerizable unsaturated functional group,
A′ is a group that may be present, which then represents a hydrocarbon radical with 1 to 4 carbon atoms, and
B′ is a hydrocarbon radical with 1 to 4 carbon atoms.

85. The process according to claim 84, wherein R is a radical selected from the group consisting of a vinyl radical, an acrylic radical, a methacrylic radical, a maleic radical, an itaconic radical, a crotonic radical, a vinylphthalic ester radical, an unsaturated urethane radical, a substituted or unsubstituted allyl ether radical, a substituted or unsubstituted vinyl ether radical, an ethylenically unsaturated amide radical, and an ethylenically unsaturated imide radical.

86. The process according to claim 85, wherein said unsaturated urethane radical is selected from the group consisting of acrylurethane, methacrylurethane, α-α′ dimethyl-isopropenyl-benzylurethane, and allylurethane.

87. The process according to claim 69, wherein said crosslinking monomer is selected from the group consisting of ethylene glycol dimethacrylate, trimethylolpropanetriacrylate, allyl acrylate, allyl maleates, methylene-bis-acrylamide, methylene-bis-methacrylamide, tetrallyloxyethane, triallylcyanurates, an allyl ether obtained from a polyol, and a monomer represented by formula (III): 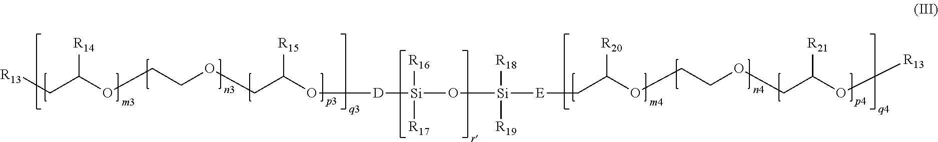
where
each of m3, n3, p3, m4, n4 and p4 represents an integer less than or equal to 150,
q3 and q4 each represent a whole number at least equal to 1 and such that 0≦(m3+n3+p3)q3≦150 and 0≦(m4+n4+p4)q4≦150,
r′ is a number such that 1≦r′≦200,
R₁₃ is a radical containing a polymerizable unsaturated functional group,
R₁₄, R₁₅, R₂₀ and R₂₁ each represent hydrogen, a methyl radical, or an ethyl radical,
R₁₆, R₁₇, R₁₈ and R₁₉ each represent a linear or branched alkyl radical, an aryl radical, an alkylaryl radical, or an arylalkyl radical with 1 to 20 carbon atoms, and
D and E are groups that may be present, which then represent a hydrocarbon radical with 1 to 4 carbon atoms.

88. The process according to claim 87, wherein R₁₃ is a radical selected from the group consisting of a vinyl radical, an acrylic radical, a methacrylic radical, a maleic radical, an itaconic radical, a crotonic radical, a vinylphthalic ester radical, an unsaturated urethane radical, a substituted or unsubstituted allyl ether radical, a substituted or unsubstituted vinyl ether radical, an ethylenically unsaturated amide radical, and an ethylenically unsaturated imide radical.

89. The process according to claim 88, wherein said unsaturated urethane radical is selected from the group consisting of acrylurethane, methacrylurethane, α-α′ dimethyl-isopropenyl-benzylurethane, and allylurethane.

90. The aqueous dispersion according to claim 69, comprising 0.05 to 5% by dry weight of said at least one water soluble polymer with respect to the dry weight of the at least one pigment, the at least one mineral filler, or combination thereof.

91. The aqueous dispersion according to claim 69, comprising 0.1 to 3% by dry weight of said at least one water soluble polymer with respect to the dry weight of the at least one pigment, the at least one mineral filler, or combination thereof.

92. The aqueous dispersion according to claim 69, wherein the pigment and the mineral filler are each selected from the group consisting of natural calcium carbonate, synthetic calcium carbonate, dolomites, kaolonite, talc, cement, gypsum, lime, magnesia, titanium oxide, satin white, aluminum trioxide, aluminum trihydroxide, silicas, mica, talc-calcium carbonate, a calcium carbonate-kaolinite mixture, a mixture of calcium carbonate with aluminum trihydroxide, a mixture of calcium carbonate with aluminum trioxide, a mixture of synthetic fibers, natural fibers, a talc-calcium carbonate co-structure, and a talc-titanium dioxide co-structure.

93. The aqueous dispersion according to claim 69, wherein said pigment is a ground pigment.

94. The aqueous dispersion according to claim 93, wherein the ground pigment is selected from the group consisting of natural calcium carbonate, synthetic calcium carbonate, dolomites, kaolonite, talc, cement, gypsum, lime, magnesia, titanium oxide, satin white, aluminum trioxide, aluminum trihydroxide, silicas, mica, talc-calcium carbonate, a calcium carbonate-kaolinite mixture, a mixture of calcium carbonate with aluminum trihydroxide, a mixture of calcium carbonate with aluminum trioxide, a mixture of synthetic fibers, natural fibers, a talc-calcium carbonate co-structure, and a talc-titanium dioxide co-structure.

95. An aqueous dispersion, comprising
water,
at least one pigment, at least one mineral filler, or a combination thereof,
and at least one water soluble polymer that has a controlled structure and is obtained by a controlled free radical polymerization of at least one monomer in the presence of an alkoxyamine polymerization initiator represented by general formula (A): 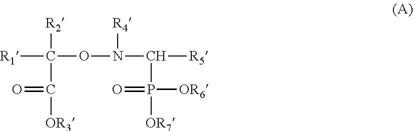
where:
R₁′ and R₂′ each independently represent a linear or branched alkyl radical with 1 to 5 carbon atoms,
R₃′ is a hydrogen atom, a linear or branched alkyl radical with 1 to 8 carbon atoms, a phenyl radical, or a cation selected from the group consisting of Li⁺,
Na⁺, K⁺, H₄N⁺, and Bu₃HN⁺ where Bu is a butyl group,
R₄′, R₅′, R₆′ and R₇′ are each independently a linear or branched alkyl radical with 1 to 8 carbon atoms,
wherein said polymer comprises as monomer units, expressed by weight:
a) 2% to 100% of at least one ionic monomer selected from the group consisting of an ethylenically unsaturated anionic monomer having a monocarboxylic functional group in the acidic or salified state; an ethylenically unsaturated anionic monomer having a dicarboxylic functional group in the acidic or salified state; an ethylenically unsaturated anionic monomer having a sulfonic functional group in the acidic or salified state; an ethylenically unsaturated anionic monomer having a phosphoric functional group in the acidic or salified state; an ethylenically unsaturated anionic monomer having a phosphonic functional group in the acidic or salified state; N-[3-(dimethylamino)propyl]acrylamide, N-[3-(dimethylamino)propyl]methacrylamide, an unsaturated ester, and a quaternary ammonium compound,
b) 0 to 98% of at least one monomer with nonionic ethylenic unsaturation represented by formula (I): 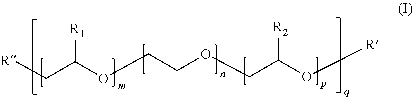
where:
m, n and p are each a number less than or equal to 150,
q is a whole number at least equal to 1 and such that 5≦(m+n+p)q≦150,
R₁ and R₂ are each independently a hydrogen, a methyl radical, or an ethyl radical,
R″ is a radical containing a polymerizable unsaturated functional group,
R′ is a hydrogen or a hydrocarbon radical with 1 to 4 carbon atoms,
c) 0% to 50% of at least one monomer selected from the group consisting of an acrylamide, a methacrylamide, a water insoluble monomer, an organofluorine compound represented by formula (IIa), and an organosilicon compound represented by formula (IIb), 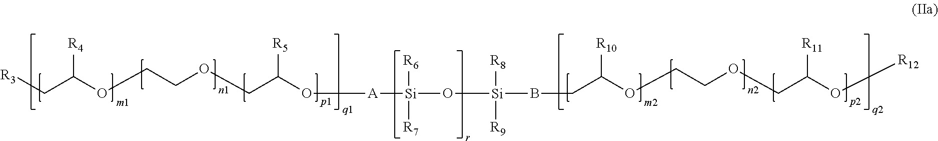
where:
each of m1, n1, p1, m2, n2, and p2 represents a number less than or equal to 150,
q1 and q2 represent a whole number at least equal to 1 and such that 0≦(m1+n1+p1)q1≦150 and 0≦(m2+n2+p2)q2≦150,
r is a number such that 1≦r≦200,
R₃ is a radical containing a polymerizable unsaturated functional group
R₄, R₅, R₁₀ and R₁₁ each represent a hydrogen, a methyl radical, or an ethyl radical,
R₆, R₇, R₈ and R₉ each represent a linear or branched alkyl radical, an aryl radical, alkylaryl radical, or an arylalkyl radical with 1 to 20 carbon atoms,
R₁₂ is a hydrocarbon radical with 1 to 40 carbon atoms,
A and B are groups that may be present, which then represent a hydrocarbon radical with 1 to 4 carbon atoms;
said organosilicon compound is a compound represented by formula (IIb):
R-A′-Si(OB′)₃ (IIb)
where:
R is a radical containing a polymerizable unsaturated functional group,
A′ is a group that may be present, which then represents a hydrocarbon radical with 1 to 4 carbon atoms, and
B′ is a hydrocarbon radical with 1 to 4 carbon atoms,
d) 0 to 3% of at least one cross-linking monomer selected from the group consisting of ethylene glycol dimethacrylate, trimethylolpropanetriacrylate, allyl acrylate, allyl maleates, methylene-bis-acrylamide, methylene-bis-methacrylamide, tetrallyloxyethane, triallylcyanurates, an allyl ether obtained from a polyol, and a monomer represented by formula (III): 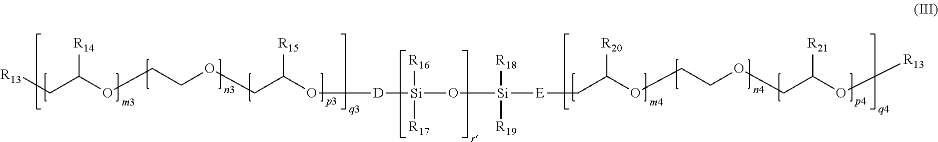
where
each of m3, n3, p3, m4, n4 and p4 represents an integer less than or equal to 150,
q3 and q4 each represent a whole number at least equal to 1 and such that 0≦(m3+n3+p3)q3≦150 and 0≦(m4+n4+p4)q4≦150,
r′ is a number such that 1≦r′≦200,
R₁₃ is a radical containing a polymerizable unsaturated functional group,
R₁₄, R₁₅, R₂₀ and R₂₂ each represent hydrogen, a methyl radical, or an ethyl radical,
R₁₆, R₁₇, R₁₈ and R₁₉ each represent a linear or branched alkyl radical, an aryl radical, an alkylaryl radical, or an arylalkyl radical with 1 to 20 carbon atoms, and
D and E are groups that may be present, which then represent a hydrocarbon radical with 1 to 4 carbon atoms,
wherein a percentage of particles of less than one micron in diameter is not greater than 58.8%,
the aqueous dispersion exhibits an initial Brookfield viscosity of at least 2680, measured at μ₁₀ and at least 1020, measured at μ₁₀₀, and
the aqueous dispersion exhibits a Brookfield viscosity, measured after resting for eight days, of at least 2600, measured at μ₁₀, and at least 970, measured at μ₁₀₀.

96. The aqueous dispersion according to claim 95, wherein said alkoxyamine represented by general formula (A) is 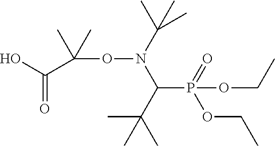
said at least one monomer is methacrylic acid, and
said at least one pigment, at least one mineral filler, or a combination thereof is calcium carbonate and said polymer is present in an amount 1.2% by weight, relative to the amount of calcium carbonate.

97. The aqueous dispersion according to claim 95, wherein each of R, R₃ and R₁₃ are independently selected from the group consisting of a vinyl radical, an acrylic ester radical, a methacrylic ester radical, a maleic ester radical, an itaconic ester radical, a crotonic ester radical, a vinylphthalic ester radical, an unsaturated urethane radical, a substituted or unsubstituted allyl ether radical, a substituted or unsubstituted vinyl ether radical, an ethylenically unsaturated amide radical, and an ethylenically unsaturated imide radical.

98. The aqueous dispersion according to claim 97, wherein said unsaturated urethane radical is selected from the group consisting of acrylurethane, methacrylurethane, dimethyl-isopropenyl-benzylurethane, and allylurethane.

99. The aqueous dispersion according to claim 95, wherein said water insoluble monomer is selected from the group consisting of an alkyl acrylate and an alkyl methacrylate.

100. The aqueous dispersion according to claim 95, wherein the polyol of said allyl ether obtained from a polyol is selected from the group consisting of pentaerythritol, sorbitol, and sucrose,

101. The aqueous dispersion according to claim 95, comprising 0.05 to 5% by dry weight of said at least one water soluble polymer with respect to the dry weight of the at least one pigment, the at least one mineral filler, or combination thereof.

102. The aqueous dispersion according to claim 95, comprising 0.1 to 3% by dry weight of said at least one water soluble polymer with respect to the dry weight of the at least one pigment, the at least one mineral filler, or combination thereof.

103. The aqueous dispersion according to claim 95, wherein the pigment and the mineral filler are each selected from the group consisting of natural calcium carbonate, synthetic calcium carbonate, dolomites, kaolonite, talc, cement, gypsum, lime, magnesia, titanium oxide, satin white, aluminum trioxide, aluminum trihydroxide, silicas, mica, talc-calcium carbonate, a calcium carbonate-kaolinite mixture, a mixture of calcium carbonate with aluminum trihydroxide, a mixture of calcium carbonate with aluminum trioxide, a mixture of synthetic fibers, natural fibers, a talc-calcium carbonate co-structure, and a talc-titanium dioxide co-structure.

104. The aqueous dispersion according to claim 95, wherein said pigment is a ground pigment.

105. The aqueous dispersion according to claim 104, wherein the ground pigment is selected from the group consisting of natural calcium carbonate, synthetic calcium carbonate, dolomites, kaolonite, talc, cement, gypsum, lime, magnesia, titanium oxide, satin white, aluminum trioxide, aluminum trihydroxide, silicas, mica, talc-calcium carbonate, a calcium carbonate-kaolinite mixture, a mixture of calcium carbonate with aluminum trihydroxide, a mixture of calcium carbonate with aluminum trioxide, a mixture of synthetic fibers, natural fibers, a talc-calcium carbonate co-structure, and a talc-titanium dioxide co-structure.
